(19) United States
(12) Patent Application Publication
(10) Pub. No.: US 2009/0278963 A1
(43) Pub. Date: Nov. 12, 2009

(54) Apparatus and method for column fixed pattern noise (FPN) correction

(75) Inventors: Joey Shah, Thousand Oaks, CA (US); John Richardson, Newbury Park, CA (US); Laurent Blanquart, Westlake Village, CA (US)

Correspondence Address: REED SMITH LLP, 101 Second Street, Suite 1800, SAN FRANCISCO, CA, 94105, US

(73) Assignee: AltaSens, Inc.

(21) Appl. No.: 12/151,916

(22) Filed: May 8, 2008

(51) Int. Cl. H04N 5/217

(52) U.S. Cl. 348/241; 348/E05.078

(57) ABSTRACT

An apparatus and method for fixed pattern noise (FPN) correction in an image sensor utilizes at least one row of test pixels. An external voltage is applied to each pixel circuit in the at least one row. Thus, the output of the test pixels does not depend on the photo or dark current signals. The applied voltage is used to determine a column offset error for each column in the image sensor.

### BACKGROUND OF THE INVENTION

1. Field of the Invention

The present invention relates generally to image sensors, and more particularly to an apparatus and method for column fixed pattern noise correction in a CMOS image sensor.

2. Description of the Related Art

Visible imaging systems implemented using CMOS image sensors reduce camera noise, cost and power while simultaneously improving resolution and capture rate. The most advanced and highest performance cameras use CMOS imaging System-on-Chip (iSoC) sensors that efficiently couple low-noise image detection and processing by using various supporting blocks integrated on a single chip.

On the other hand, CMOS iSoC's are prone to producing image artifacts that are by-products of the specific analog readout architecture used to capture the image. A common example of one such image artifact is column Fixed Pattern Noise (FPN), which arises when each column of pixels has a different fixed offset. These offsets are caused by the fact that each column of pixels is sampled by a physically different column circuit. All column circuits are designed to be identical, but due to process, voltage, and temperature variations over the sensor, there are differences between the circuits in each column.

Since these offsets are applied to each column, the offsets can become visible in an image. When the peak-to-peak variation of such offsets is sufficiently high so as to make the columns visible in the still or video image, steps must be taken to correct it since column FPN can be most evident at nominal gain.

Various techniques are used to correct FPN in both the analog circuits located throughout the sensor's signal chain and in the downstream digital circuitry. In the latter case, the downstream circuits can be on-chip or off-chip, i.e., in the downstream camera electronics. An early example of an image sensor that used an external differential amplifier to subtract the stored FPN data from the two-dimensional sensor's video output is taught in U.S. Pat. No. 3,067,283.

Other prior art instead integrated FPN suppression in the iSoC by either analog or digital means. U.S. Pat. No. 5,892,540, for example, teaches a self-correcting column buffer that actively suppresses column offsets in the analog domain to the order of tens of microvolts as each pixel is read out at each column. While this methodology corrects each column buffer's dc offset, it does not correct offsets generated later in the signal processing chain. Nevertheless, the '540 patent improved on earlier FPN compensation methods that first determined FPN in the absence of the light, stored the offset terms, and then compensated for FPN while generating the video stream, such as both the '283 patent and U.S. Pat. No. 3,949,162. The '162 patent corrects the offsets in the analog domain after digitally acquiring the data.

It was determined that it is necessary to include dedicated optically black (OB) pixels (pixels shielded from light pickup) in the image sensor and that these should be located in the periphery surrounding the light-sensing area. OB pixels are useful to optimize black clamping and to properly facilitate fixed pattern noise compensation. U.S. Pat. No. 4,678,938 hence teaches column-wise and row-wise embodiments for reading OB pixels in a feedback-controlled manner to dynamically eliminate offsets in each column or row. U.S. Pat. No. 4,839,729 later improves the efficacy of the '938 patent by instead reading each line of active video at the same time as a stored line of OB video and using the differential amplifier scheme pioneered in the '283 patent to eliminate FPN. U.S. Pat. No. 6,788,340, later combined the various cited and other prior art to teach an integrated solution that could be included in a single iSoC. The '340 patent specifically combines optically black pixels, which are located at the periphery of the image sensor, with a digital controller and differential programmable gain amplifier 24. Nevertheless, the '340 patent does not teach specific means and an effective algorithm for correcting FPN. Instead, the focus of the '340 patent is to enable dynamic adjustment of the video to always use the largest possible ADC range and to optimize image brightness. U.S. Pat. No. 7,098,950 later improved on black clamp operation by not including defective pixels.

As noted above, a typical way to address this issue is to use the output of a fixed number of optically black rows and determine the offset values for each column. This value is then stored and when the clear image pixels are read out, the offset is applied per column (typically in the digital domain) to reduce or eliminate the FPN. In order to make the FPN invisible to the human eye (especially at high gain settings), often many rows of OB pixels are required. For example, if the offset is calculated by simply taking an average of the black rows, the noise in the stored offset for each column would be the noise from a single black pixel divided by the square root of the number of sampled rows. So, if a reduction of a factor of 10 from the noise of single pixel is desired, this would require 100 rows. However, this number of black rows reduces the effective imaging area of the image sensor.

Thus, it would be desirable to have a solution for correcting column fixed pattern noise in an image sensor which does not require a large number of black rows, but does not sacrifice performance.

### SUMMARY OF THE INVENTION

A column fixed pattern noise (FPN) correction circuit according to one embodiment of the present invention comprises a first test row comprising a plurality of pixel circuits, each pixel circuit having a floating diffusion node, and a test signal line connected to each floating diffusion node, wherein a test signal is applied to each pixel in the first test row via the test signal line and an output signal is double-sampled to determine a column offset for each pixel column. The first test row may be sampled a plurality of times to determine a column offset for each pixel column. A switch may be connected in series with the test signal.

A method for column fixed pattern noise correction in an image sensor according to one embodiment of the present invention comprises applying a test signal to a floating diffusion node of each pixel in a test row, double-sampling an output signal from each pixel in the test row to determine a column offset value, and storing the column offset value for each column of pixels in a memory; wherein the column offset value is applied to image signals read out from each column during image signal readout. The steps of applying and double sampling can be repeated a predefined number of times.

According to another embodiment of the present invention, a column fixed pattern noise (FPN) correction circuit comprises a first test row comprising a plurality of pixel circuits, each pixel circuit having a floating diffusion node and a readout transistor, a first test signal line connected to the floating diffusion node of each pixel in the first test row, a first readout signal line connected to the readout transistor of each pixel in the first test row, a second test row comprising a plurality of pixel circuits, each pixel circuit having a floating diffusion node, a second test signal line connected to the floating diffusion node of each pixel in the second test row, and a second readout signal line connected to the readout transistor of each pixel in the second test row. The column fixed pattern noise (FPN) correction circuit may further comprise a first reset signal and a first video signal switchably connected to the first readout signal line, and a second reset signal and a second video signal switchably connected to the second readout signal line. The first video signal and the second reset signal are connected to the first readout signal line and the second readout signal line, respectively, during a first period, and the first reset signal and the second video signal are connected to the first readout signal line and the second readout signal line, respectively, during a second period.

A method for column fixed pattern noise correction in an image sensor according to an additional embodiment comprises applying a first test signal to a floating diffusion node of each pixel in a first test row, applying a second test signal to a floating diffusion node of each pixel in a second test row, applying a first video signal to a readout transistor in each pixel in the first test row, applying a second reset signal to a readout transistor in each pixel in the second test row, sampling a first output signal on each column of pixels to determine a first column offset value, applying a first reset signal to a readout transistor in each pixel in the first test row, applying a second video signal to a readout transistor in each pixel in the second test row, sampling a second output signal on each column of pixels to determine a second column offset value, determining a final column offset value based on the first and second column offset values, and storing the final column offset value for each column of pixels in a memory; wherein the column offset value is applied to image signals read out from each column during image signal readout.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a schematic of an embodiment of a test row circuit according to the present invention; and

FIG. 2 is a schematic of an alternate embodiment of a test row circuit according to the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

According to one embodiment of the present invention, a “test row” is repeatedly sampled to determine a column fixed pattern noise (FPN) offset for each column. A test row is a row of pixels whose output does not depend on a photo or dark current signal, but on an externally applied voltage (i.e. a signal external to the pixel array). The voltage may be supplied by a reference voltage on the sensor, from a programmable DAC (Digital-to-Analog Converter), or from a source outside the sensor. The test signal is applied to the floating diffusion in each pixel.

This solution takes advantage of the fact that column FPN is caused primarily by the column parallel circuitry. So instead of reading many rows of pixels to determine the offset of the column circuitry, the present invention applies a test signal to the column circuitry and samples the output from each column numerous times to calculate an accurate offset value for each column. Thus, the present invention does not require many black rows, which otherwise take up area on the image sensor.

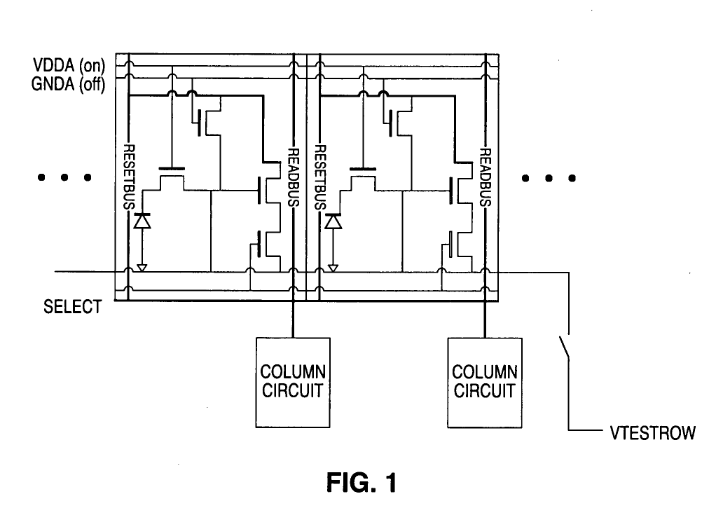

An example of a sensor test row is shown in FIG. 1. To avoid adding the noise from the external voltage source to the pixel output, the voltage is sampled onto the gate of the source follower amplifier in each pixel of the test row. The signal is then read repeatedly. The circuit shown in FIG. 1 is an example of a four transistor (4T) implementation, but the concepts of the present invention can be advantageously applied to other pixel configurations as well.

As shown in the figure, the gate of the transfer transistor (M1) is on to evacuate any photo or dark current generated electrons. The gate of the reset transistor M2 is off to prevent shorting the RESETBUS to the external voltage VTESTROW. A switch S1 can be connected in series with the voltage VTESTROW to allow for sampling of the voltage onto the floating diffusions in the row. This sampling may occur every row, once per frame, or otherwise as needed. As long as the voltage is not refreshed while the pixel output is being double sampled, the noise from the external power supply will be eliminated. As is known in the art, double sampling reads two samples from each pixel—one before the image signal is applied, and one after the image signal is applied. The difference between the two signals is then used as the image signal.

Sampling VTESTROW may not be necessary in certain circumstances, and the voltage can be continuously applied, depending on the noise of the source used to supply VTESTROW. In practice, the actual voltage used for VTESTROW is not that critical, as long as double sampling is used and the difference of the two samples is used to determine the column offset.

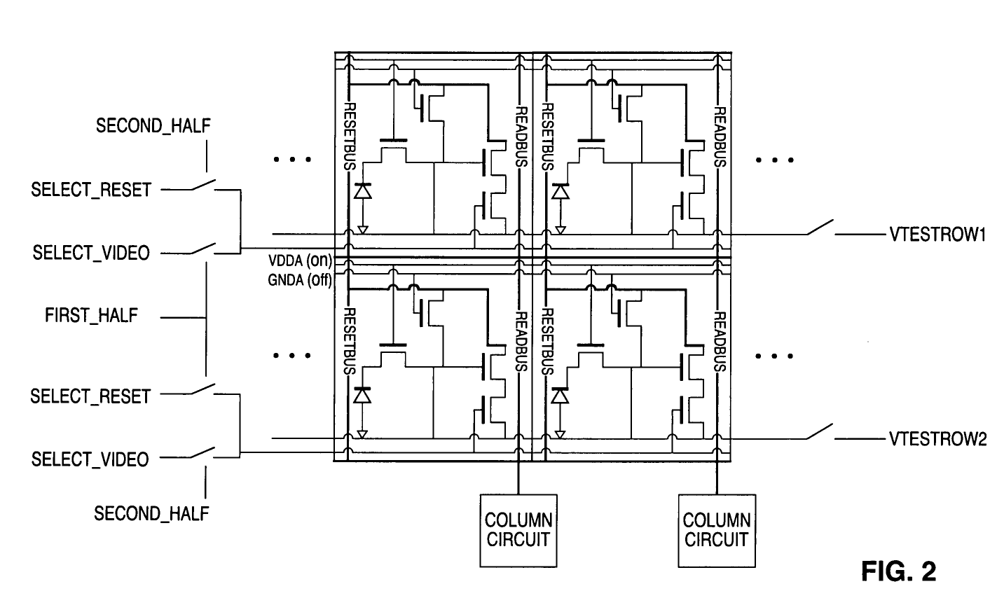

A second embodiment of the present invention is shown in FIG. 2. In this embodiment, two test rows are utilized. One test row is used as a reset level and the other test row is used as a video level.

One possible drawback to using two test rows is that the mismatch between the source follower amplifiers in the pixels will be added to the FPN for each column. This mismatch can actually be much worse than the actual column FPN, since the source followers are typically very small geometry devices.

One solution is to switch which row is being used as the reset and which is used as the video halfway through the total number of samples of the test rows used for FPN correction. For example, the input signals can be switched halfway through the sampling cycle, as shown in FIG. 2. As long as the weighting of the pixels is the same on the second half as the first half of the sampling cycle, the threshold mismatches will be cancelled.

For FPN correction, the video and reset levels are typically set to levels very close to each other to avoid storing a signal offset in the FPN correction offset value. Under certain circumstances, it may be advantageous to have the video and reset levels different from each other, such as for gain correction.

Column gain calibration could be performed by creating different test signals from different video and reset levels, and then adjusting the gain of the column, and measuring the output of the columns. These gain offsets could then be stored in memory for each column, so that as the gain is adjusted, the column gain mismatch can be corrected.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A column fixed pattern noise (FPN) correction circuit comprising:
a first test row comprising a plurality of pixel circuits, each pixel circuit having a floating diffusion node; and
a test signal line connected to each floating diffusion node;
wherein a test signal is applied to each pixel in the first test row via the test signal line and an output signal is double-sampled to determine a column offset for each pixel column.

2. The column FPN correction circuit of claim 1, wherein the first test row is sampled a plurality of times to determine a column offset for each pixel column.

3. The column FPN correction circuit of claim 1, further comprising a switch connected in series with the test signal.

4. A method for column fixed pattern noise correction in an image sensor comprising:
applying a test signal to a floating diffusion node of each pixel in a test row;
double-sampling an output signal from each pixel in the test row to determine a column offset value;
and
storing the column offset value for each column of pixels in a memory;
wherein the column offset value is applied to image signals read out from each column during image signal readout.

5. The method of claim 4, wherein the steps of applying and double sampling are repeated a predefined number of times.

6. A column fixed pattern noise (FPN) correction circuit comprising:
a first test row comprising a plurality of pixel circuits, each pixel circuit having a floating diffusion node and a readout transistor;
a first test signal line connected to the floating diffusion node of each pixel in the first test row;
a first readout signal line connected to the readout transistor of each pixel in the first test row;
a second test row comprising a plurality of pixel circuits, each pixel circuit having a floating diffusion node;
a second test signal line connected to the floating diffusion node of each pixel in the second test row; and
a second readout signal line connected to the readout transistor of each pixel in the second test row.

7. The column fixed pattern noise (FPN) correction circuit of claim 6, further comprising:
a first reset signal and a first video signal switchably connected to the first readout signal line; and
a second reset signal and a second video signal switchably connected to the second readout signal line.

8. The column fixed pattern noise (FPN) correction circuit of claim 7, wherein the first video signal and the second reset signal are connected to the first readout signal line and the second readout signal line, respectively, during a first period, and the first reset signal and the second video signal are connected to the first readout signal line and the second readout signal line, respectively, during a second period.

9. A method for column fixed pattern noise correction in an image sensor comprising:
applying a first test signal to a floating diffusion node of each pixel in a first test row;
applying a second test signal to a floating diffusion node of each pixel in a second test row;
applying a first video signal to a readout transistor in each pixel in the first test row;
applying a second reset signal to a readout transistor in each pixel in the second test row;
sampling a first output signal on each column of pixels to determine a first column offset value;
applying a first reset signal to a readout transistor in each pixel in the first test row;
applying a second video signal to a readout transistor in each pixel in the second test row;
sampling a second output signal on each column of pixels to determine a second column offset value;
determining a final column offset value based on the first and second column offset values; and
storing the final column offset value for each column of pixels in a memory; wherein the column offset value is applied to image signals read out from each column during image signal readout.
